(19) United States
(12) Patent Application Publication
(10) Pub. No.: US 2021/0208175 A1
(43) Pub. Date: Jul. 8, 2021

(54) FLUID DEVICE

(71) Applicant: NIKON CORPORATION, Tokyo (JP)

(72) Inventors: Ryo KOBAYASHI, Kawasaki-shi (JP); Taro UENO, Tokyo (JP); Naoya ISHIZAWA, Saitama-shi (JP)

(21) Appl. No.: 16/770,048

(22) PCT Filed: Dec. 11, 2017
(86) PCT No.: PCT/JP2017/044332

§ 371 Date: Nov. 16, 2020

(51) Int. Cl. G01N 35/08; B01F 13/00

(52) U.S. Cl. CPC G01N 35/08; B01F 13/0059

(57) ABSTRACT

A fluid device includes a substrate which has a pair of substrate plates stacked in a thickness direction thereof, wherein the substrate is provided with a flow path which is formed by covering a groove portion provided in one substrate plate of the pair of substrate plates with the other substrate plate, wherein the flow path includes a merging portion, and a supply flow path, a discharge flow path, and a branch flow path which extend radially from the merging portion, wherein a discharge valve is provided between the merging portion and the discharge flow path, wherein a branch valve is provided between the merging portion and the branch flow path, wherein the merging portion is filled with a solution by causing the solution to flow from the supply flow path toward the discharge flow path in a state in which the branch valve is closed, and wherein in the merging portion, a dimension of a region adjacent to the discharge valve in the thickness direction is smaller than a dimension of a region adjacent to the supply flow path in the thickness direction and a dimension of a region adjacent to the branch valve in the thickness direction.

### TECHNICAL FIELD

The present invention relates to a fluid device.

### BACKGROUND ART

In recent years, the development of micro-total analysis systems (μ-TAS) aimed at speeding up, improving the efficiency of and integrating tests in the in-vitro diagnostic field, or ultra-miniaturization of inspection equipment has attracted attention, and active research thereon has been underway worldwide.

μ-TAS is superior to inspection equipment of the related art in that measurement and analysis are possible with a small amount of sample, portability is possible, and disposal is possible at low cost.

Furthermore, μ-TAS has attracted attention as a highly useful method in a case in which expensive reagents are used or in a case in which a small number of multiple samples are tested.

As a constituent element of μ-TAS, a device provided with a flow path and a pump disposed in the flow path has been reported (Non-Patent Document 1). In such a device, a plurality of solutions are injected into the flow path and a pump is operated to mix the plurality of solutions in the flow path.

### CITATION LIST

### Non-Patent Literature

### [Non-Patent Document 1]

Jong Wook Hong, Vincent Studer, Giao Hang, W French Anderson and Stephen R Quake, Nature Biotechnology 22, 435-439 (2004)

### SUMMARY OF INVENTION

According to a first embodiment, there is provided a fluid device including a substrate which has a pair of substrate plates stacked in a thickness direction thereof, wherein the substrate is provided with a flow path which is formed by covering a groove portion provided in one substrate plate of the pair of substrate plates with the other substrate plate, wherein the flow path includes a merging portion, and a supply flow path, a discharge flow path, and a branch flow path which extend radially from the merging portion, wherein a discharge valve is provided between the merging portion and the discharge flow path, wherein a branch valve is provided between the merging portion and the branch flow path, wherein the merging portion is filled with a solution by causing the solution to flow from the supply flow path toward the discharge flow path in a state in which the branch valve is closed, and wherein in the merging portion, a dimension of a region adjacent to the discharge valve in the thickness direction is smaller than a dimension of a region adjacent to the supply flow path in the thickness direction and a dimension of a region adjacent to the branch valve in the thickness direction.

According to a second embodiment, there is provided a fluid device including a substrate which has a pair of substrate plates stacked in a thickness direction thereof, wherein the substrate is provided with a flow path which is formed by covering a groove portion provided in one substrate plate of the pair of substrate plates with the other substrate plate, wherein the flow path includes an inflow portion, and an introduction flow path, a supply flow path, and a branch flow path which extend radially from the inflow portion, wherein the supply flow path and the branch flow path face each other with the inflow portion interposed therebetween, wherein a branch valve is provided between the inflow portion and the branch flow path, wherein the inflow portion is filled with a solution by causing the solution to flow from the introduction flow path toward the supply flow path in a state in which the branch valve is closed, wherein the inflow portion has a facing wall surface that faces the introduction flow path, and wherein a distance between the introduction flow path and the facing wall surface is larger than a distance between the introduction flow path and the branch valve.

### BRIEF DESCRIPTION OF DRAWINGS

FIG. 1 is a cross-sectional view schematically showing a fluid device according to an embodiment.

FIG. 2 is a plan view schematically showing the fluid device according to the embodiment.

FIG. 3 is an enlarged view of an inflow portion of the fluid device according to the embodiment.

FIG. 4 is an enlarged view of a merging portion of the fluid device according to the embodiment.

FIG. 5 is a perspective view of the merging portion of the fluid device according to the embodiment.

FIG. 6 is a cross-sectional view of a connecting portion between the merging portion and a branch valve in the fluid device according to the embodiment.

FIG. 7 is an enlarged view of an inflow portion of a modification example.

FIG. 8 is an enlarged view of a merging portion of a modification example.

### DESCRIPTION OF EMBODIMENTS

Hereinafter, embodiments of a fluid device, a reservoir supply system, and a flow path supply system will be described with reference to the drawings. Note that in the drawings used in the following description, to make characteristics easy to understand, characteristic portions may be shown enlarged for convenience, and it is not always the case that the dimensional ratios of constituent elements and the like are the same as the actual ones.

### Fluid Device

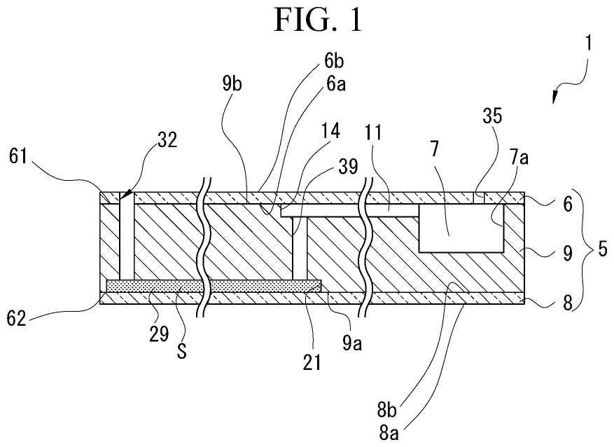

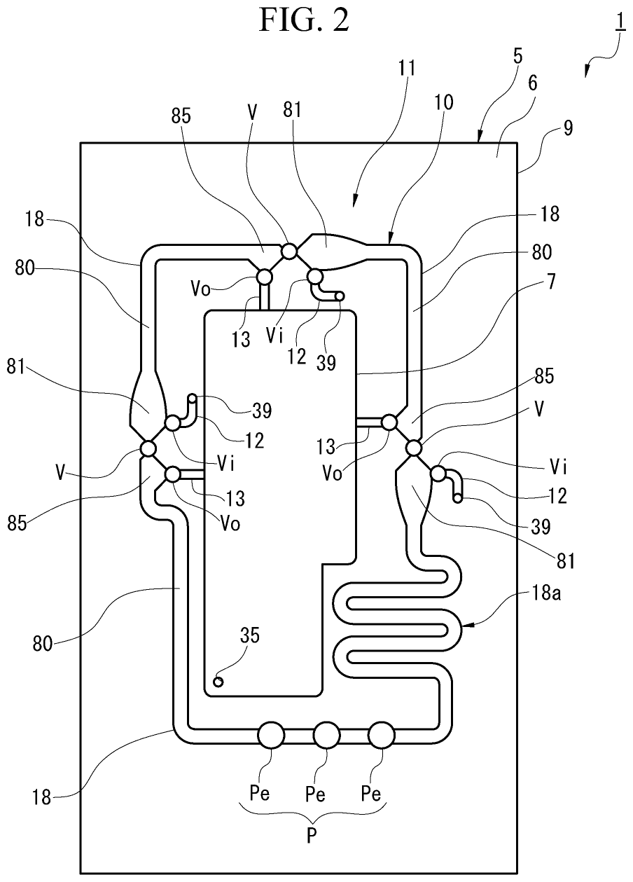

FIG. 1 is a schematic cross-sectional view of a fluid device 1 of the present embodiment. FIG. 2 is a plan view schematically showing the fluid device 1. Note that in FIG. 2, a transparent upper plate 6 is illustrated in a state in which the portions disposed on a side below thereof are viewed through the upper plate.

The fluid device 1 of the present embodiment includes a device that detects a sample substance that is a detection target contained in a specimen sample using an immunoreaction, an enzymatic reaction, or the like. The sample substance is, for example, a biomolecule such as nucleic acid, DNA, RNA, a peptide, a protein, or extracellular endoplasmic reticulum.

As shown in FIG. 2, the fluid device 1 includes a substrate 5 and a plurality of valves V, Vi, and Vo. Further, as shown in FIG. 1, the substrate 5 has three substrate plates (an upper plate 6, a substrate plate 9, and a lower plate 8) stacked in a thickness direction. The upper plate 6, the lower plate 8 and the substrate plate 9 of the present embodiment are formed of a resin material. Examples of the resin material forming the upper plate 6, the lower plate 8, and the substrate plate 9 include polypropylene, polycarbonate, and the like. Further, in the present embodiment, the upper plate 6 and the lower plate 8 are formed of a transparent material. Note that the materials forming the upper plate 6, the lower plate 8, and the substrate plate 9 are not limited.

In the following description, the upper plate (for example, a first substrate plate (a substrate plate), a lid, an upper portion or a lower portion of a flow path, and an upper surface or a bottom surface of a flow path) 6, the lower plate (for example, a third substrate plate (a substrate plate), a lid, an upper portion or a lower portion of a flow path, and an upper surface or a bottom surface of a flow path) 8, and the substrate plate (a second substrate plate) 9 are disposed along a horizontal plane, the upper plate 6 is disposed on a side above the substrate plate 9, and the lower plate 8 is disposed on a side below the substrate plate 9. Here, a horizontal direction and a vertical direction are defined merely for the convenience of description, and the orientation of the fluid device 1 according to the present embodiment during use is not limited.

The upper plate 6, the substrate plate 9, and the lower plate 8 are plate members extending in the horizontal direction. The upper plate 6, the substrate plate 9, and the lower plate 8 are stacked in this order in the vertical direction. That is, the substrate plate 9 is stacked on the upper plate 6 on a side below the upper plate 6. Further, the lower plate 8 is stacked on the substrate plate 9 on a surface (a lower surface 9a) opposite to the upper plate 6.

Note that in the following description, a direction in which the upper plate 6, the substrate plate 9, and the lower plate 8 are stacked is simply called a stacking direction. In the present embodiment, the stacking direction is the vertical direction. Further, in the present embodiment, the stacking direction is the thickness direction of the substrate plates (the upper plate 6, the substrate plate 9, and the lower plate 8).

The upper plate 6 has an upper surface 6b and a lower surface 6a. The substrate plate 9 has an upper surface 9b and a lower surface 9a. Similarly, the lower plate 8 has an upper surface 8b and a lower surface 8a.

The lower surface 6a of the upper plate 6 faces the upper surface 9b of the substrate plate 9 in the stacking direction and is in contact therewith. The lower surface 6a of the upper plate 6 and the upper surface 9b of the substrate plate 9 are joined to each other by joining means such as bonding. The lower surface 6a of the upper plate 6 and the upper surface 9b of the substrate plate 9 form a first boundary surface (a first joining surface) 61. That is, the upper plate 6 and the substrate plate 9 are joined to each other at the first boundary surface 61.

Similarly, the upper surface 8b of the lower plate 8 faces the lower surface 9a of the substrate plate 9 in the stacking direction and is in contact therewith. The upper surface 8b of the lower plate 8 and the lower surface 9a of the substrate plate 9 are joined to each other by a joining means such as bonding. The upper surface 8b of the lower plate 8 and the lower surface 9a of the substrate plate 9 form a second boundary surface (a second joining surface) 62. That is, the substrate plate 9 and the lower plate 8 are joined to each other at the second boundary surface 62.

The substrate 5 is provided with an injection hole 32, a reservoir 29, a flow path 11, a waste liquid tank 7, an air hole 35, and a supply hole 39.

The injection hole 32 penetrates the upper plate 6 and the substrate plate 9. The injection hole 32 is connected to the reservoir 29 located at a boundary between the substrate plate 9 and the lower plate 8. The injection hole 32 connects the reservoir 29 to the outside. A solution is filled into the reservoir 29 via the injection hole 32. One injection hole 32 is provided for each reservoir 29. Note that the illustration of the injection hole 32 is omitted in FIG. 2.

The reservoir 29 is a tube-shaped or cylindrical space surrounded by an inner wall surface of a groove portion 21 provided in the lower surface 9a of the substrate plate 9 and the lower plate 8. That is, the reservoir 29 is located in the second boundary surface 62. The substrate 5 of the present embodiment is provided with a plurality of the reservoirs 29. The solution is accommodated in the reservoir 29. The plurality of reservoirs 29 accommodate the solutions independently of each other. The reservoir 29 supplies the accommodated solution to the flow path 11. The reservoir 29 of the present embodiment is a flow-path type reservoir. One end of the reservoir 29 in a length direction is connected to the injection hole 32. Further, the other end of the reservoir 29 in the length direction is connected to the supply hole 39.

Note that in the present embodiment, a case in which the reservoir 29 is formed by providing the groove portion 21 in the substrate plate 9 and covering an opening of the groove portion 21 with the lower plate 8 is described. However, the reservoir 29 may be formed by covering an opening of a groove portion provided in the lower plate 8 with the substrate plate 9.

The flow path 11 is a tube-shaped or cylindrical space surrounded by an inner wall surface of a groove portion 14 provided in the upper surface 9b of the substrate plate 9 and the upper plate 6. That is, the flow path 11 is located in the first boundary surface 61. The solution is supplied to the flow path 11 from the reservoir 29. The solution flows in the flow path 11.

Note that in the present embodiment, a case in which the flow path 11 is formed by providing the groove portion 14 in the substrate plate 9 and covering an opening of the groove portion 14 with the upper plate 6 is described. However, the flow path 11 may be formed by covering an opening of a groove portion provided in the upper plate 6 with the substrate plate 9. That is, it is sufficient that the substrate 5 have a pair of substrate plates stacked in the thickness direction and the flow path 11 be formed by covering a groove portion provided in one substrate plate of the pair of substrate plates with the other substrate plate.

Each portion of the flow path 11 will be described later in detail with reference to FIG. 2.

The supply hole 39 is provided in the substrate plate 9. The supply hole 39 penetrates the substrate plate 9 in a substrate plate thickness direction. The supply hole 39 connects together the reservoir 29 and the flow path 11. The solution stored in the reservoir 29 is supplied to the flow path 11 via the supply hole 39. That is, the reservoir 29 is connected to the flow path 11 via the supply hole 39.

The waste liquid tank 7 is provided in the substrate 5 to discard the solution in the flow path 11. The waste liquid tank 7 is connected to the flow path 11. As shown in FIG. 2, the waste liquid tank 7 is disposed in an inner region of a circulation flow path 10. This makes it possible to reduce the size of the fluid device 1. Further, as shown in FIG. 1, the waste liquid tank 7 is formed in a space surrounded by an inner wall surface of a concave portion 7a provided in the upper surface 9b of the substrate plate 9 and the upper plate 6 which covers an opening of the concave portion 7a facing upward.

The air hole 35 is provided in the upper plate 6. The air hole 35 is located directly above the waste liquid tank 7. The air hole 35 connects the waste liquid tank 7 to the outside. That is, the waste liquid tank 7 is open to the outside through the air hole (a device connection hole) 35.

Next, the flow path 11 will be described more specifically.

As shown in FIG. 2, the flow path 11 includes a circulation flow path 10, a plurality of (three in the example of FIG. 2) introduction flow paths 12, and a plurality of (three in the example of FIG. 2) discharge flow paths 13. The solution is introduced into the flow path 11 from the reservoir 29 (refer to FIG. 1).

When viewed in the stacking direction, the circulation flow path 10 is formed in a loop shape. A pump P is disposed in the path of the circulation flow path 10. The pump P is constituted by three element pumps Pe disposed side by side in the flow path. The element pump Pe is a so-called valve pump. The pump P can transport the liquid in the circulation flow path by sequentially opening and closing the three element pumps Pe. The number of element pumps Pe constituting the pump P may be four or more.

A plurality of (three in the example of FIG. 2) metering valves (branch valves) V are provided in the path of the circulation flow path 10. The plurality of metering valves V divide the circulation flow path 10 into a plurality of metering sections 18. The plurality of metering valves V are disposed such that each metering section 18 has a predetermined volume. In the present embodiment, a meandering portion 18a is provided in one metering section of the three metering sections 18. The meandering portion 18a is a flow path formed by meandering left and right. The meandering portion 18a is provided to make one metering section 18 have a desired volume.

Each metering section 18 extends in a flow path shape. Each of the plurality of metering sections 18 has a supply flow path 80 in a flow path shape, an inflow portion 81 located at one end of the supply flow path 80, and a merging portion 85 provided at the other end of the supply flow path 80. Therefore, in each of the metering sections 18, the supply flow path 80 is located between the inflow portion 81 and the merging portion 85.

The inflow portion 81 of one metering section 18 is connected to the merging portion 85 of the other metering section 18 via the metering valve V. Further, the introduction flow path 12 is connected to the inflow portion 81 via an introduction valve Vi.

Similarly, the merging portion 85 of one metering section 18 is connected to the inflow portion 81 of the other metering section 18 via the metering valve V. Further, the discharge flow path 13 is connected to the merging portion 85 via a discharge valve Vo.

Details of the inflow portion 81 and the merging portion 85 will be described later.

The introduction flow path 12 is a flow path for introducing the solution into the metering section 18 of the circulation flow path 10. The introduction flow path 12 is provided for each metering section 18 of the circulation flow path 10. The introduction flow path 12 is connected to the supply hole 39 at one end side. Further, the introduction flow path 12 is connected to the inflow portion 81 of the circulation flow path 10 at the other end side.

The discharge flow path 13 is a flow path for discharging the solution in the metering section 18 of the circulation flow path 10 to the waste liquid tank 7. The discharge flow path 13 is provided for each metering section 18 of the circulation flow path 10. The discharge flow path 13 is connected to the waste liquid tank 7 at one end side. Further, the discharge flow path 13 is connected to the merging portion 85 of the circulation flow path 10 at the other end side.

### Procedure to Supply Solution from Reservoir to Flow Path

Next, a procedure of supplying a solution S from the reservoir 29 to the flow path 11 in the fluid device 1 will be described.

As shown in FIG. 1, the reservoir 29 is filled with the solution S in advance. In the measurement using the fluid device 1, first, the solution S in the reservoir 29 is moved to the flow path 11. More specifically, the solution S is sequentially introduced into each metering section 18 of the circulation flow path 10 from the reservoir 29. Here, the procedure of introducing the solution S into one metering section 18 will be described, but the solution S is also introduced into other metering sections 18 by performing the same procedure.

The opening and closing of the valves V, Vi, and Vo when introducing the solution S into the metering section 18 will be described with reference to FIG. 2. First, a pair of the metering valves V located on both sides in the length direction of the metering section 18 into which the solution S is introduced are closed. Furthermore, the discharge valve Vo of the discharge flow path 13 connected to this metering section 18 is opened, and the discharge valves Vo of other discharge flow paths 13 are closed. Further, the introduction valve Vi of the introduction flow path 12 connected to this metering section 18 is opened.

A procedure of moving the solution from the reservoir 29 to the flow path 11 will be described with reference to FIG. 1. Using a suction device (not shown), the inside of the waste liquid tank 7 is sucked through the air holes 35 under negative pressure. Accordingly, the solution S in the reservoir 29 is moved to the flow path 11 via the supply hole 39. Further, the air that has passed through the injection hole 32 is introduced into a rear side of the solution S in the reservoir 29. Accordingly, the flow path supply system 4 introduces the solution S accommodated in the reservoir 29 into the metering section 18 of the circulation flow path 10 via the supply hole 39 and the introduction flow path 12.

### Procedure of Mixing Solution in Flow Path

Next, a procedure of mixing the solution supplied to the flow path of the fluid device 1 will be described with reference to FIG. 2. First, as described above, in a state in which the solution has been introduced into each metering section 18 of the circulation flow path 10, the discharge valve Vo and the introduction valve Vi are closed and the metering valve V is opened. Furthermore, the solution in the circulation flow path 10 is sent and circulated using the pump P. Due to the interaction (friction) between a flow path wall surface in the flow path and the solution, the solution being circulated in the circulation flow path 10 has a low flow velocity around the wall surface and a high flow velocity at the center of the flow path. As a result, a distribution is present in the flow velocity of the solution, which promotes the mixing and reaction of the solution.

### Inflow Portion

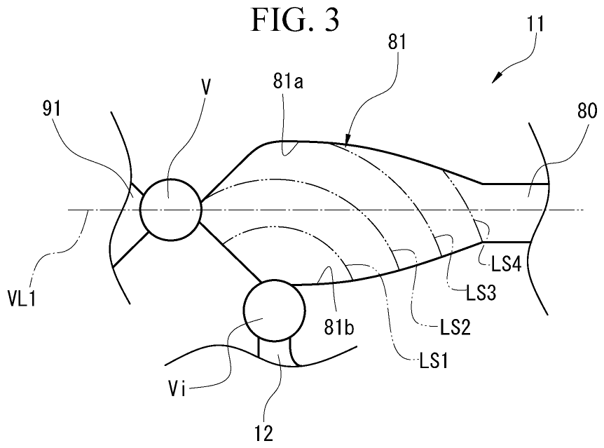

FIG. 3 is an enlarged view of the inflow portion 81 provided in the flow path 11.

Note that in the following description, the other metering section 18 connected to the inflow portion 81 via the metering valve V is referred to as a branch flow path 91. Further, the metering valve will be referred to as a branch valve V.

The introduction flow path 12, the supply flow path 80, and the branch flow path 91 are connected to the inflow portion 81. That is, the flow path 11 includes the inflow portion 81, the introduction flow path 12, the supply flow path 80, and the branch flow path 91. The introduction flow path 12, the supply flow path 80, and the branch flow path 91 extend radially from the inflow portion 81.

The branch valve V is provided between the inflow portion 81 and the branch flow path 91, and the introduction valve Vi is provided between the inflow portion 81 and the introduction flow path 12. On the other hand, no valve is provided between the inflow portion 81 and the supply flow path 80.

The supply flow path 80 and the branch flow path 91 face each other with the inflow portion 81 interposed therebetween. Further, the introduction flow path 12 extends in a direction orthogonal to a first virtual line VL1 that connects together the supply flow path 80 and the branch flow path 91.

When viewed in the stacking direction, the inflow portion 81 widens and then narrows again in width as it goes from the supply flow path 80 toward the branch flow path 91. When viewed in the stacking direction, the inflow portion 81 is formed substantially symmetrically with respect to the first virtual line VL1. When viewed in the stacking direction, the inflow portion 81 has a first wall surface (a facing wall surface) 81a and a second wall surface 81b.

The first wall surface 81a is connected to a wall surface of the supply flow path 80. Further, the first wall surface 81a is connected to the branch valve V. The first wall surface 81a faces the introduction flow path 12 with the first virtual line VL1 interposed therebetween. The first wall surface 81a gradually separates from the first virtual line VL1 until it reaches a region on a side opposite to the branch valve V with the first virtual line VL1 interposed therebetween from the supply flow path 80. Further, the first wall surface 81a gradually approaches the first virtual line VL1 until it reaches the branch valve V from the region on the side opposite to the branch valve V with the first virtual line VL1 interposed therebetween.

The second wall surface 81b is connected to the wall surface of the supply flow path 80. The second wall surface 81b is connected to the branch valve V. Further, the introduction valve Vi is located in the second wall surface 81b. The second wall surface 81b faces the first wall surface 81a with the first virtual line VL1 interposed therebetween. The first wall surface 81a and the second wall surface 81b are formed substantially symmetrically with respect to the first virtual line VL1. The second wall surface 81b gradually separates from the first virtual line VL1 until it reaches the introduction valve Vi from the supply flow path 80. Further, the second wall surface 81b linearly extends to approach the first virtual line VL1 as it goes from the introduction valve Vi toward the branch valve V.

The inflow portion 81 is filled with the solution by causing the solution to flow from the introduction flow path 12 toward the supply flow path 80 in a state in which the branch valve V is closed. At this time, the introduction valve Vi is opened. The solution flows into the inflow portion 81 from the introduction flow path 12, so that a liquid surface position is changed in the order of a first liquid surface LS1, a second liquid surface LS2, a third liquid surface LS3, and a fourth liquid surface LS4 shown in FIG. 3.

According to the present embodiment, the liquid surface of the solution spreads in a substantially arc shape by causing the solution to flow into the inflow portion 81 from the introduction flow path 12. The liquid surface of the solution first spreads along the second wall surface 81b, as indicated by the first liquid surface LS1. Then, the liquid surface of the solution reaches the branch valve V as indicated by the second liquid surface LS2. Further, the liquid surface of the solution spreads along the first wall surface 81a and the second wall surface 81b, as indicated by the third liquid surface LS3. Finally, the liquid surface of the solution reaches the supply flow path 80 as indicated by the fourth liquid surface LS4.

According to the present embodiment, in the inflow portion 81, a distance between the introduction flow path 12 and the first wall surface 81a is larger than a distance between the introduction flow path 12 and the branch valve V. Accordingly, in the inflow portion 81, the solution fills the region in the vicinity of the branch valve V before the liquid surface position reaches the first wall surface 81a. Therefore, it is possible to prevent bubbles from accumulating in the inflow portion 81 in the process in which the inflow portion 81 is filled with the solution. That is, according to the present embodiment, it is possible to fill the metering section 18 (refer to FIG. 2) of the flow path 11 with the solution without bubbles, and thus it is possible to perform accurate metering of the solution.

According to the present embodiment, when viewed in the stacking direction, the inflow portion 81 is formed substantially symmetrically with respect to the first virtual line VL1 that connects together the supply flow path 80 and the branch flow path 91. Thus, even in a case in which the solution is introduced from the branch flow path 91 to fill the inflow portion 81, the liquid surface of the solution spreads to be substantially symmetrical with respect to the first virtual line VL1 and reaches the supply flow path 80. Therefore, even in a case in which the inflow portion 81 is filled with the solution from the branch flow path 91, it is possible to suppress generation of bubbles in the inflow portion 81.

### Merging Portion

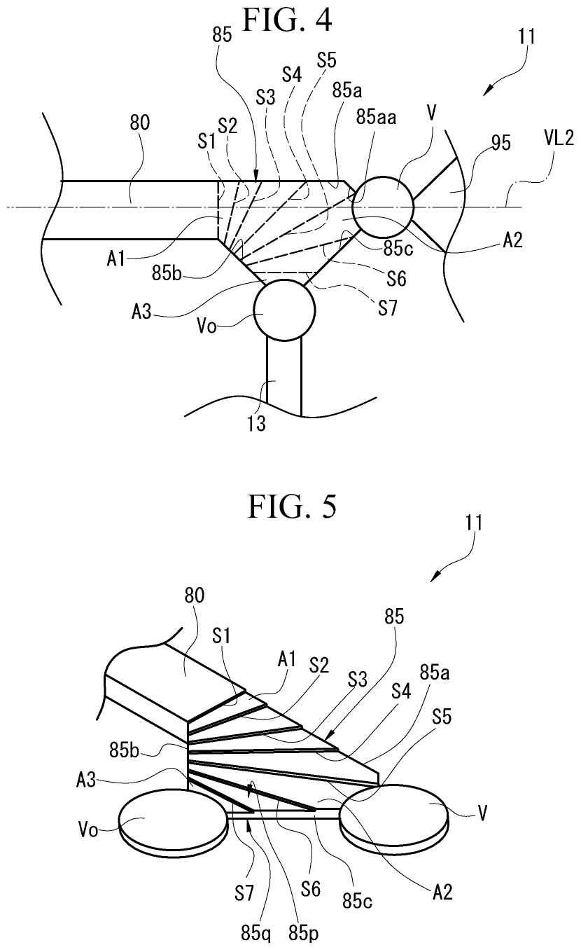

FIG. 4 is an enlarged view of the merging portion 85 provided in the flow path 11. Further, FIG. 5 is a perspective view of the merging portion 85.

Note that in the following description, the other metering section 18 connected to the merging portion 85 via the metering valve V is referred to as a branch flow path 95. Further, the metering valve will be referred to as a branch valve V.

As shown in FIG. 4, the supply flow path 80, the discharge flow path 13, and the branch flow path 95 are connected to the merging portion 85. That is, the flow path 11 includes the introduction flow path 12, the discharge flow path 13, the supply flow path 80, and the branch flow path 95. The supply flow path 80, the discharge flow path 13, and the branch flow path 95 extend radially from the merging portion 85.

A branch valve V is provided between the merging portion 85 and the branch flow path 95, and the discharge valve Vo is provided between the merging portion 85 and the discharge flow path 13. On the other hand, no valve is provided between the merging portion 85 and the supply flow path 80.

The supply flow path 80 and the branch flow path 95 face each other with the merging portion 85 interposed therebetween. Further, the discharge flow path 13 extends in a direction orthogonal to a second virtual line VL2 that connects together the supply flow path 80 and the branch flow path 95.

When viewed in the stacking direction, the merging portion 85 is formed in a substantially right-angled isosceles triangle shape. The discharge flow path 13 is connected to the merging portion 85 at a 90° corner portion of the right-angled isosceles triangle. Further, the supply flow path 80 and the branch flow path 95 are connected to the merging portion 85 at 45° corner portions of the right-angled isosceles triangle.

When viewed in the stacking direction, the merging portion 85 has a first wall surface (a side wall surface) 85a, a second wall surface (a side wall surface) 85b, and a third wall surface (a side wall surface) 85c. The first wall surface 85a is a wall surface that faces the 90° corner portion of the right-angled isosceles triangle shape.

The first wall surface 85a is connected to a wall surface of the supply flow path 80. Further, the first wall surface 85a is connected to the branch valve V. The first wall surface 85a faces the discharge flow path 13 with the second virtual line VL2 interposed therebetween. The first wall surface 85a extends linearly along the wall surface of the supply flow path 80. Further, the first wall surface 85a has a slanted surface 85aa near the branch valve V, which is slanted to approach the second virtual line VL2 as it goes toward the branch valve V. The slanted surface 85aa is provided to smoothly guide the solution in the merging portion 85 to the branch valve V.

The second wall surface 85b is connected to the wall surface of the supply flow path 80. Further, the second wall surface 85b is connected to the introduction valve Vi. The second wall surface 85b faces the first wall surface 85a with the second virtual line VL2 interposed therebetween. The second wall surface 85b linearly extends to gradually separate from the second virtual line VL2 until it reaches the introduction valve Vi from the supply flow path 80. That is, when viewed in the stacking direction, the merging portion 85 has the second wall surface 85b that linearly connects together the supply flow path 80 and the discharge valve Vo.

The third wall surface 85c connects together the discharge valve Vo and the branch valve V. The third wall surface 85c faces the first wall surface 85a with the second virtual line VL2 interposed therebetween. The third wall surface 85c linearly extends to gradually approach the second virtual line VL2 until it reaches the branch valve V from the discharge valve Vo. That is, when viewed in the stacking direction, the merging portion 85 has the third wall surface 85c that linearly connects together the discharge valve Vo and the branch valve V.

As shown in FIG. 5, the merging portion 85 is a space spreading in the stacking direction between a top surface 85p and a bottom surface 85q. A plurality of step portions (a first step portion S1, a second step portion S2, a third step portion S3, a fourth step portion S4, a fifth step portion S5, a sixth step portion S6, and a seventh step portion S7) are provided in the top surface 85p of the merging portion 85. When viewed in the stacking direction, the first to seventh step portions S1 to S7 each extend linearly. The distance between the top surface 85p and the bottom surface 85q of the merging portion 85 in the stacking direction rapidly changes with the respective first to seventh step portions S1 to S7 as boundaries.

The first step portion S1 is located at a boundary between the supply flow path 80 and the merging portion 85. The first step portion S1 reduces the dimension of the merging portion 85 in the stacking direction with respect to the dimension of the supply flow path 80 in the stacking direction.

The second to fifth step portions S2 to S5 extend from the second wall surface 85b toward the first wall surface 85a. The second to fifth step portions S2 to S5 are disposed side by side in this order from the supply flow path 80 toward the branch valve V. The second to fifth step portions S2 to S5 reduce the dimension of the merging portion 85 in the stacking direction in this order as they go from the supply flow path 80 toward the branch valve V.

The sixth and seventh step portions S6 and S7 extend from the second wall surface 85b toward the third wall surface 85c. The sixth and seventh step portions S6 and S7 are disposed side by side in this order from the branch valve V toward the discharge valve Vo. The sixth and seventh step portions S6 and S7 reduce the dimension of the merging portion 85 in the stacking direction in this order as they go from the branch valve V toward the discharge valve Vo.

The merging portion 85 is filled with the solution by causing the solution to flow from the supply flow path 80 toward the discharge flow path 13 in a state in which the branch valve V is closed. At this time, the discharge valve Vo is opened.

The merging portion 85 is provided with a first region A1 adjacent to the supply flow path 80, a second region A2 adjacent to the branch valve V, and a third region A3 adjacent to the discharge valve Vo.

The first region A1 is located between the first step portion S1 and the second step portion S2.

The second region A2 is located between the fifth step portion S5 and the sixth step portion S6. Further, the merging portion 85 is connected to the branch valve V in the second region A2.

The third region A3 is located between the seventh step portion S7 and the discharge valve Vo. Therefore, the merging portion 85 is connected to the discharge valve Vo in the third region A3.

The dimension of the third region A3 in the stacking direction is smaller than the dimension of the first region A1 in the stacking direction and the dimension of the second region A2 in the stacking direction. In particular, the dimension of the third region A3 in the stacking direction is a region in the merging portion 85 which has the smallest dimension in the stacking direction. Further, the dimension of the second region A2 in the stacking direction is smaller than the dimension of the first region A1 in the stacking direction.

Generally, in a flow path through which a fluid flows, a flow path resistance is increased by reducing a flow path cross-sectional area. Further, the fluid is likely to flow preferentially in a direction in which the flow path resistance is small.

According to the present embodiment, the dimension of the third region A3 in the stacking direction is smaller than the dimensions of the first region A1 and the second region A2 in the stacking direction, and thus it is difficult for the solution to flow into the third region A3 compared to the first region A1 and the second region A2. Thus, the solution flowing from the supply flow path 80 into the merging portion 85 fills the first region A1 and the second region A2 and then reaches the third region A3. During the process in which the solution flows into the merging portion 85, bubbles are likely to be generated in connecting portions between the merging portion 85 and the flow paths (the supply flow path 80 and the branch flow path 95). According to the present embodiment, the solution is likely to fill the first region A1 and the second region A2 before the third region A3 in the merging portion 85. Accordingly, in the process in which the solution flows from the supply flow path 80 toward the discharge flow path 13, generation of bubbles in the connecting portions between the merging portion 85 and the flow paths (the supply flow path 80 and the branch flow path 95) is suppressed.

Further, according to the present embodiment, in the dimension of the merging portion 85 in the stacking direction, the third region A3 has the smallest dimension. Therefore, in the merging portion 85, the third region A3 has the largest flow path resistance. Thus, in the entire merging portion 85, the third region A3 is a region where the solution is most unlikely to flow. As a result, the solution flowing from the supply flow path 80 into the merging portion 85 finally flows into the third region A3, so that it is possible to suppress generation of bubbles in the merging portion 85. That is, according to the present embodiment, it is possible to fill the metering section 18 of the flow path 11 with the solution without bubbles, and thus it is possible to perform accurate metering of the solution.

According to the present embodiment, the dimension of the second region A2 adjacent to the branch valve V in the stacking direction is smaller than the dimension of the first region A1 in the stacking direction, so that it is difficult for the solution to flow into the second region A2 compared to the first region A1. Thus, the solution flowing from the supply flow path 80 into the merging portion 85 fills the first region A1 and then reaches the second region A2. According to the present embodiment, the solution is likely to fill the first region A1 adjacent to the supply flow path 80 before the second region A2 in the merging portion 85. Accordingly, in the process in which the solution flows from the supply flow path 80 toward the discharge flow path 13, generation of bubbles in the connecting portions with the supply flow path 80 is suppressed.

According to the present embodiment, the first step portion S1 is provided between the supply flow path 80 and the merging portion 85. The solution flowing from the supply flow path 80 toward the merging portion 85 is prevented from wet spreading by the surface tension in a stage in which the solution reaches the first step portion S1. Thus, the solution reaches the entire width of the first step portion S1, and then the solution overflows from the first step portion and flows into the merging portion 85. That is, the first step portion S1 functions as a gate between the supply flow path 80 and the merging portion 85. Such a function is a function that each of other step portions (the second to seventh step portions S2 to S7) also has. According to the present embodiment, the first step portion S1 is provided between the supply flow path 80 and the merging portion 85, so that the solution flows into the merging portion 85 after the supply flow path 80 is filled with the solution. Therefore, as a result, it is possible to suppress generation of bubbles in the supply flow path 80.

According to the present embodiment, the merging portion 85 has the step portions (the second to fourth step portions S2 to S4) located between the first region A1 and the second region A2. The second to fourth step portions S2 to S4 function as gates as described above. The solution flowing from the first region A1 toward the second region A2 fills a region between the first step portion S1 and the second step portion S2 and then reaches a region between the second step portion S2 and the third step portion S3. Next, the solution fills a region between the second step portion S2 and the third step portion S3, a region between the third step portion S3 and the fourth step portion S4, and a region between the fourth step portion S4 and the fifth step portion S5 in order. Further, the solution reaches a region between the fifth step portion S5 and the sixth step portion S6 in which the second region A2 is provided.

That is, according to the present embodiment, the solution sequentially fills the regions between the step portions between the first region A1 and the second region A2, so that it is possible to suppress generation of bubbles in the merging portion 85 between the first region A1 and the second region A2.

Further, according to the present embodiment, the merging portion 85 has the step portions (the sixth step portion S6 and seventh step portion S7) located between the first region A1 and the second region A2, and the third region A3. The solution fills a region between the fifth step portion S5 and the sixth step portion S6 in which the second region A2 is provided and then reaches a region between the sixth step portion S6 and the seventh step portion S7. Further, the solution fills the region between the sixth step portion S6 and the seventh step portion S7 and then reaches a region between the seventh step portion S7 and the discharge valve Vo, and flows into the discharge flow path 13 through the opened discharge valve Vo.

That is, according to the present embodiment, the solution sequentially fills the regions between the step portions between the second region A2 and the third region A3, so that it is possible to suppress generation of bubbles in the merging portion 85 between the second region A2 and the third region A3.

Note that in the present embodiment, a case in which the step portion is provided on the top surface 85p of the merging portion 85 has been illustrated. However, it is sufficient that the step portion can drastically change the dimension of the merging portion 85 in the stacking direction. The step portion may be provided on both the top surface 85p and the bottom surface 85q, or may be provided only on the bottom surface 85q, for example.

According to the present embodiment, the second wall surface 85b that connects together the supply flow path 80 and the discharge valve Vo, and the third wall surface 85c that connects together the discharge valve Vo and the branch valve V are linear when viewed in the stacking direction. Thus, formation of a corner portion at the merging portion 85 is curbed, and thus generation of bubbles in the process in which the merging portion 85 is filled with the solution can be suppressed.

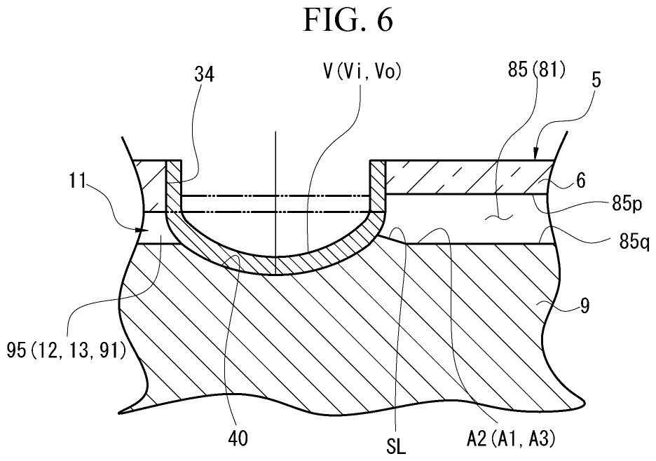

Next, a structure that can be employed for the connecting portion between the merging portion 85 and the branch valve V will be described with reference to FIG. 6.

Here, the structure for the connecting portion between the merging portion 85 and the branch valve V is shown as a representative, but the same structure having a slanted portion SL can be employed for the connecting portion between the merging portion 85 and the discharge valve Vo, the connecting portion between the inflow portion 81 and the branch valve V, and the connecting portion between the inflow portion 81 and the introduction valve Vi.

First, the structure of the branch valve V will be described.

The upper plate 6 is provided with a valve holding hole 34 for holding the branch valve V. The branch valve V is held in the valve holding hole 34 by the upper plate 6. The branch valve V is formed of an elastic material. Examples of the elastic materials that can be employed for the branch valve V include rubber, elastomer resin, and the like. A hemispherical recess 40 is provided in the flow path 11 immediately below the branch valve V. As shown in FIG. 6, the branch valve V closes the flow path 11 by elastically deforming downward and coming into contact with the recess 40. Further, the branch valve V opens the flow path 11 by separating from the recess 40 (a virtual line (two-dot dashed line) in FIG. 6).

Note that such a valve structure is the same for other valves (the introduction valve Vi and the discharge valve Vo).

The bottom surface 85q of the merging portion 85 is provided with the slanted portion SL that is located at the boundary between the branch valve V and the merging portion 85 and in which a distance to the top surface 85p decreases going toward the branch valve V. By providing the slanted portion SL, the solution can be smoothly spread to the branch valve V of the merging portion 85 when the merging portion 85 is filled with the solution. In particular, as compared to a case in which a corner portion is provided at the boundary between the branch valve V and the merging portion 85, generation of bubbles in the merging portion 85 can be effectively suppressed by providing the slanted portion SL.

In the present embodiment, the case in which the slanted portion SL is provided on the bottom surface 85q of the merging portion 85 has been described. However, it is sufficient that the merging portion 85 have the slanted portion SL that reduces the dimension in the stacking direction as it goes toward the branch valve V in the region (the second region A2) adjacent to the branch valve V. That is, the slanted portion SL may be provided on both the top surface 85p and the bottom surface 85q, or may be provided only on the top surface 85p.

Further, if the merging portion 85 has the slanted portion SL in a region adjacent to at least one valve of the discharge valve Vo and the branch valve V, generation of bubbles in the region can be suppressed. Similarly, if the inflow portion 81 has the slanted portion SL in a region adjacent to at least one valve of the introduction valve Vi and the branch valve V, generation of bubbles in the region can be suppressed.

### Modification Example of Inflow Portion

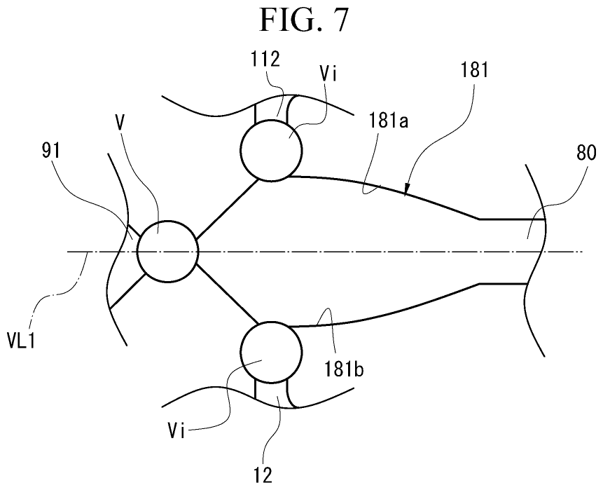

An inflow portion 181 of a modification example which can be employed in the above-described embodiment will be described based on FIG. 7. Note that, the same constituent elements as those in the above-described embodiment are designated by the same reference numerals, and the description thereof will be omitted.

FIG. 7 is an enlarged view of the inflow portion 181 of the modification example. As shown in FIG. 7, a first introduction flow path (an introduction flow path) 12, a second introduction flow path (an introduction flow path) 112, a supply flow path 80, and a branch flow path 91 are connected to the inflow portion 181. That is, the flow path 11 includes the inflow portion 181, two introduction flow paths (the first introduction flow path 12 and the second introduction flow path 112), the supply flow path 80, and the branch flow path 91. The first introduction flow path 12, the second introduction flow path 112, the supply flow path 80, and the branch flow path 91 extend radially from the inflow portion 181.

A branch valve V is provided between the inflow portion 181 and the branch flow path 91. An introduction valve Vi is provided between the inflow portion 181 and the first introduction flow path 12 and between the inflow portion 181 and the second introduction flow path 112. On the other hand, no valve is provided between the inflow portion 181 and the supply flow path 80.

The supply flow path 80 and the branch flow path 91 face each other with the inflow portion 181 interposed therebetween. Further, the first introduction flow path 12 and the second introduction flow path 112 extend in a direction each orthogonal to a first virtual line VL1 that connects together the supply flow path 80 and the branch flow path 91. The first introduction flow path 12 and the second introduction flow path 112 are disposed on sides opposite to each other with the first virtual line VL1 interposed therebetween. Further, the first introduction flow path 12 and the second introduction flow path 112 are disposed symmetrically to each other with respect to the first virtual line VL1.

When viewed in the stacking direction, the inflow portion 181 widens and then narrows again in width as it goes from the supply flow path 80 toward the branch flow path 91. When viewed in the stacking direction, the inflow portion 181 is formed substantially symmetrically with respect to the first virtual line VL1. When viewed in the stacking direction, the inflow portion 181 has a first wall surface (a facing wall surface) 181a and a second wall surface (a facing wall surface) 181b.

The first wall surface 181a is connected to a wall surface of the supply flow path 80. The first wall surface 181a is connected to the branch valve V. Further, the introduction valve Vi of the second introduction flow path 112 is located in the first wall surface 181a. The first wall surface 181a faces the first introduction flow path 12 with the first virtual line VL1 interposed therebetween. The first wall surface 181a gradually separates from the first virtual line VL1 until it reaches the introduction valve Vi from the supply flow path 80. Further, the first wall surface 181a linearly extends to approach the first virtual line VL1 as it goes from the introduction valve Vi toward the branch valve V.

The second wall surface 181b is connected to the wall surface of the supply flow path 80. The second wall surface 181b is connected to the branch valve V. Further, the introduction valve Vi of the first introduction flow path 12 is located in the second wall surface 181b. The second wall surface 181b faces the first wall surface 181a with the first virtual line VL1 interposed therebetween. The first wall surface 181a and the second wall surface 181b are formed substantially symmetrically with respect to the first virtual line VL1. The second wall surface 181b gradually separates from the first virtual line VL1 until it reaches the introduction valve Vi from the supply flow path 80. Further, the second wall surface 181b linearly extends to approach the first virtual line VL1 as it goes from the introduction valve Vi toward the branch valve V.

The first introduction flow path 12 is provided in the second wall surface 181b that faces the second introduction flow path 112. Further, the second introduction flow path 112 is provided in the first wall surface 181a that faces the first introduction flow path 12. That is, one introduction flow path of the two introduction flow paths (the first introduction flow path 12 and the second introduction flow path 112) of the present modification example is located in the facing wall surface that faces the other introduction flow path.

The solution is introduced into the inflow portion 181 from the first introduction flow path 12 or the second introduction flow path 112. In a case in which the solution is introduced from the first introduction flow path 12 into the inflow portion 181, the solution flows from the first introduction flow path 12 toward the supply flow path 80 in a state in which the branch valve V and the introduction valve Vi of the second introduction flow path 112 are closed. Similarly, in a case in which the solution is introduced from the second introduction flow path 112 into the inflow portion 181, the solution flows from the second introduction flow path 112 toward the supply flow path 80 in a state in which the branch valve V and the introduction valve Vi of the first introduction flow path 12 are closed.

According to the modification example, in the inflow portion 181, a distance between the first introduction flow path 12 and the first wall surface 181a is larger than a distance between the first introduction flow path 12 and the branch valve V. Thus, in a case in which the solution is introduced from the first introduction flow path 12 into the inflow portion 181, the solution fills the region in the vicinity of the branch valve V before the liquid surface position reaches the first wall surface 181a.

Similarly, in the inflow portion 181, a distance between the second introduction flow path 112 and the second wall surface 181b is larger than a distance between the second introduction flow path 112 and the branch valve V. Thus, in a case in which the solution is introduced from the second introduction flow path 112 into the inflow portion 181, the solution fills the region in the vicinity of the branch valve V before the liquid surface position reaches the second wall surface 181b.

That is, according to the present modification example, in any case in which the solution is introduced from the first introduction flow path 12 or the second introduction flow path 112 into the inflow portion 181, it is possible to fill the metering section 18 (refer to FIG. 2) of the flow path 11 with the solution without bubbles, and thus it is possible to perform accurate metering of the solution.

In addition, according to the present modification example, when viewed in the stacking direction, the inflow portion 181 is formed substantially symmetrically with respect to the first virtual line VL1. Thus, even in a case in which the solution is introduced from the branch flow path 91 to fill the inflow portion 181, the liquid surface of the solution spreads to be substantially symmetrical with respect to the first virtual line VL1 and reaches the supply flow path 80. Therefore, even in a case in which the inflow portion 181 is filled with the solution from the branch flow path 91, it is possible to suppress generation of bubbles in the inflow portion 181.

### Modification Example of Merging Portion

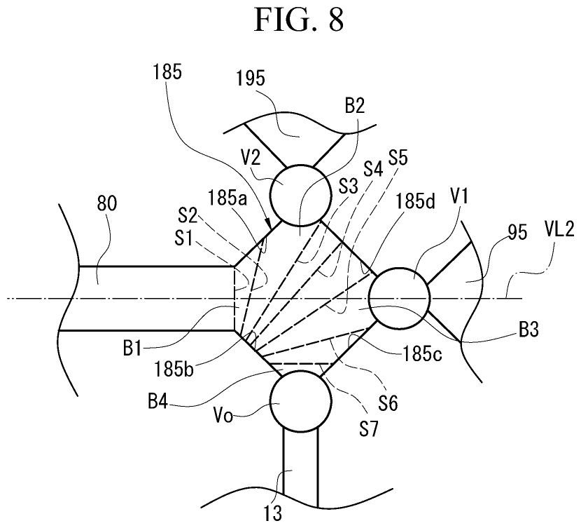

A merging portion 185 of a modification example which can be employed in the above-described embodiment will be described based on FIG. 8. Note that, the same constituent elements as those in the above-described embodiment are designated by the same reference numerals, and the description thereof will be omitted.

FIG. 8 is an enlarged view of the merging portion 185 of the modification example. As shown in FIG. 8, a supply flow path 80, a discharge flow path 13, a first branch flow path (a branch flow path) 95, and a second branch flow path (a branch flow path) 195 are connected to the merging portion 185. That is, the flow path 11 includes the introduction flow path 12, the discharge flow path 13, the supply flow path 80, the first branch flow path 95, and the second branch flow path 195. The supply flow path 80, the discharge flow path 13, the first branch flow path 95, and the second branch flow path 195 extend radially from the merging portion 185.

A first branch valve (a branch valve) V1 is provided between the merging portion 185 and the first branch flow path 95. A second branch valve (a branch valve) V2 is provided between the merging portion 185 and the second branch flow path 195. A discharge valve Vo is provided between the merging portion 185 and the discharge flow path 13. On the other hand, no valve is provided between the merging portion 185 and the supply flow path 80.

The supply flow path 80 and the first branch flow path 95 face each other with the merging portion 185 interposed therebetween. Further, the discharge flow path 13 and the second branch flow path 195 extend in a direction each orthogonal to a second virtual line VL2 that connects together the supply flow path 80 and the first branch flow path 95. The discharge flow path 13 and the second branch flow path 195 are disposed on sides opposite to each other with the second virtual line VL2 interposed therebetween. Further, the discharge flow path 13 and the second branch flow path 195 are disposed symmetrically to each other with respect to the second virtual line VL2.

When viewed in the stacking direction, the merging portion 185 is formed in a substantially square shape. The supply flow path 80, the discharge flow path 13, the first branch flow path 95, and the second branch flow path 195 are connected to the merging portion 185 at corner portions of the square.

When viewed in the stacking direction, the merging portion 185 has a first wall surface (a side wall surface) 185a, a second wall surface (a side wall surface) 185b, a third wall surface (a side wall surface) 185c, and a fourth wall surface (a side wall surface) 185d. The first wall surface 185a, the second wall surface 185b, the third wall surface 185c, and the fourth wall surface 185d each constitutes each side of a square.

The first wall surface 185a is connected to a wall surface of the supply flow path 80. Further, the first wall surface 185a is connected to the second branch valve V2. The first wall surface 185a faces the second wall surface 185b with the second virtual line VL2 interposed therebetween. The first wall surface 185a linearly extends to gradually separate from the second virtual line VL2 until it reaches the second branch valve V2 from the supply flow path 80. That is, when viewed in the stacking direction, the merging portion 185 has the first wall surface 185a that linearly connects together the supply flow path 80 and the second branch valve V2.

The second wall surface 185b is connected to the wall surface of the supply flow path 80. Further, the second wall surface 185b is connected to an introduction valve Vi. The second wall surface 185b faces the first wall surface 185a with the second virtual line VL2 interposed therebetween. The second wall surface 185b linearly extends to gradually separate from the second virtual line VL2 until it reaches the introduction valve Vi from the supply flow path 80. That is, when viewed in the stacking direction, the merging portion 185 has the second wall surface 185b that linearly connects together the supply flow path 80 and the discharge valve Vo.

The third wall surface 185c connects together the discharge valve Vo and the first branch valve V1. The third wall surface 185c faces the fourth wall surface 185d with the second virtual line VL2 interposed therebetween. The third wall surface 185c linearly extends to gradually approach the second virtual line VL2 until it reaches the first branch valve V1 from the discharge valve Vo. That is, when viewed in the stacking direction, the merging portion 185 has the third wall surface 185c that linearly connects together the discharge valve Vo and the first branch valve V1.

The fourth wall surface 185d connects together the first branch valve V1 and the second branch valve V2. The fourth wall surface 185d faces the third wall surface 185c with the second virtual line VL2 interposed therebetween. The fourth wall surface 185d linearly extends to gradually approach the second virtual line VL2 until it reaches the first branch valve V1 from the second branch valve V2. That is, when viewed in the stacking direction, the merging portion 185 has the fourth wall surface 185d that linearly connects together the first branch valve V1 and the second branch valve V2.

A plurality of step portions (a first step portion S1, a second step portion S2, a third step portion S3, a fourth step portion S4, a fifth step portion S5, a sixth step portion S6, and a seventh step portion S7) are provided in the merging portion 185. The first to seventh step portions S1 to S7 each extend linearly.

The first step portion S1 is located at a boundary between the supply flow path 80 and the merging portion 185. The first step portion S1 reduces the dimension of the merging portion 185 in the stacking direction with respect to the dimension of the supply flow path 80 in the stacking direction.

The second step portion S2 extends from the second wall surface 185b toward the first wall surface 185a. The second step portion S2 reduces the dimension of the merging portion 185 in the stacking direction in this order as it goes from the supply flow path 80 toward the second branch valve V2.

The third to fifth step portions S3 to S5 extend from the second wall surface 185b toward the first wall surface 185a. The third to fifth step portions S3 to S5 are disposed side by side in this order from the supply flow path 80 toward the first branch valve V1. The third to fifth step portions S3 to S5 reduce the dimension of the merging portion 185 in the stacking direction in this order as they go from the supply flow path 80 toward the first branch valve V1.

The sixth and seventh step portions S6 and S7 extend from the second wall surface 185b toward the third wall surface 185c. The sixth and seventh step portions S6 and S7 are disposed side by side in this order from the first branch valve V1 toward the discharge valve Vo. The sixth and seventh step portions S6 and S7 reduce the dimension of the merging portion 185 in the stacking direction in this order as they go from the first branch valve V1 toward the discharge valve Vo.

The merging portion 185 is filled with the solution by causing the solution to flow from the supply flow path 80 toward the discharge flow path 13 in a state in which the first branch valve V1 and the second branch valve V2 are closed. At this time, the discharge valve Vo is opened.

The merging portion 185 is provided with a first region B1 adjacent to the supply flow path 80, a second region B2 adjacent to the second branch valve V2, a third region B3 adjacent to the first branch valve V1, and a fourth region B4 adjacent to the discharge valve Vo.

The first region B1 is located between the first step portion S1 and the second step portion S2.

The second region B2 is located between the second step portion S2 and the third step portion S3. Further, the merging portion 185 is connected to the second branch valve V2 in the second region B2.

The third region B3 is located between the fifth step portion S5 and the sixth step portion S6. Further, the merging portion 185 is connected to the first branch valve V1 in the third region B3.

The fourth region B4 is located between the seventh step portion S7 and the discharge valve Vo. Therefore, the merging portion 185 is connected to the discharge valve Vo in the fourth region B4.

In the present modification example, the dimension of the merging portion 185 in the stacking direction becomes smaller in the order of the first region B1, the second region B2, the third region B3, and the fourth region B4. In the merging portion 185, the flow path resistance increases in the order of the first region B1, the second region B2, the third region B3, and the fourth region B4. Thus, the solution flows in the merging portion 185 in the order of the first region B1, the second region B2, the third region B3, and the fourth region B4. As a result, it is possible to suppress generation of bubbles in the merging portion 185.

In addition, according to the present modification example, the step portions are each disposed between the first region B1, the second region B2, the third region B3, and the fourth region B4 to reduce the dimension in the stacking direction in this order. Each step portion functions as a gate. Therefore, the solution fills the region interposed between the pair of step portions, and then the solution flows into the region interposed between the pair of step portions in the subsequent stage. In this way, by providing the step portions in the merging portion 185, it is possible to control the liquid surface position inside the merging portion 185 and to suppress generation of bubbles in the merging portion 185.

In the present modification example, the merging portion 185 has a substantially square shape, and each flow path is connected to a corner portion of the merging portion. That is, a side wall surface (the first wall surface 185a) that connects together the supply flow path 80 and the second branch valve V2, a side wall surface (the second wall surface 185b) that connects together the supply flow path 80 and the discharge valve Vo, a side wall surface (the third wall surface 185c) that connects together the discharge valve Vo and the first branch valve V1, and a side wall surface (the fourth wall surface 185d) that connects together the first branch valve V1 and the second branch valve V2 are each linear when viewed in the stacking direction. Thus, formation of a corner portion at the merging portion 185 is curbed, and thus generation of bubbles in the process in which the merging portion 185 is filled with the solution can be suppressed.

In the present modification example, the first branch valve V1 and the second branch valve V2 are disposed adjacent to each other in a circumferential direction centered on the merging portion 185. The first branch valve V1 is disposed adjacent to the discharge valve Vo in the circumferential direction centered on the merging portion. The second branch valve V2 is disposed adjacent to the supply flow path 80 in the circumferential direction centered on the merging portion 185. Further, in the merging portion 185, the dimension of the third region B3 in the stacking direction is smaller than the dimension of the second region B2 in the stacking direction. Thus, it is possible that the solution flowing from the supply flow path 80 into the merging portion 185 fills the second region B2 and the third region B3 in this order in the circumferential direction and then reaches the fourth region B4.

Although the embodiments of the present invention and the modification examples thereof have been described above, each configuration and the combination thereof in each of the embodiments and the modification examples are examples, and additions, omissions, substitutions, and other changes of the configuration can be made without departing from the spirit of the present invention. The present invention is not limited by the embodiments.

### REFERENCE SIGNS LIST

1 Fluid device

5 Substrate

9 Substrate plate

11 Flow path

12 Introduction flow path (first introduction flow path)

13 Discharge flow path

14, 21 Groove portion

80 Supply flow path

81, 181 Inflow portion

81a, 181a First wall surface (facing wall surface)

81b, 181b Second wall surface (facing wall surface)

85, 185 Merging portion

85a, 185a First wall surface (side wall surface)

85b, 185b Second wall surface (side wall surface)

85c, 185c Third wall surface (side wall surface)

91 Branch flow path

95 First branch flow path (branch flow path)

112 Second introduction flow path (introduction flow path)

185d Fourth wall surface (side wall surface)

195 Second branch flow path (branch flow path)

S Solution

SL Slanted portion

V Branch valve (metering valve)

V1 First branch valve (branch valve)

V2 Second branch valve (branch valve)

Vi Introduction valve

Vo Discharge valve

VL1 First virtual line (virtual line)

VL2 Second virtual line (virtual line)

1. A fluid device comprising:
a substrate which has a pair of substrate plates stacked in a thickness direction thereof,
wherein the substrate is provided with a flow path which is formed by covering a groove portion provided in one substrate plate of the pair of substrate plates with the other substrate plate,
wherein the flow path includes a merging portion, and a supply flow path, a discharge flow path, and a branch flow path which extend radially from the merging portion,
wherein a discharge valve is provided between the merging portion and the discharge flow path,
wherein a branch valve is provided between the merging portion and the branch flow path,
wherein the merging portion is filled with a solution by causing the solution to flow from the supply flow path toward the discharge flow path in a state in which the branch valve is closed, and
wherein in the merging portion, a dimension of a region adjacent to the discharge valve in the thickness direction is smaller than a dimension of a region adjacent to the supply flow path in the thickness direction and a dimension of a region adjacent to the branch valve in the thickness direction.

2. The fluid device according to claim 1, wherein the merging portion has step portions located between the region adjacent to the discharge valve, the region adjacent to the supply flow path, and the region adjacent to the branch valve.

3. The fluid device according to claim 1, wherein in the merging portion, the dimension of the region adjacent to the branch valve in the thickness direction is smaller than the dimension of the region adjacent to the supply flow path in the thickness direction.

4. The fluid device according to claim 3, wherein the merging portion has step portions located between the region adjacent to the branch valve and the region adjacent to the supply flow path.

5. The fluid device according to claim 1, wherein when viewed in the thickness direction of the substrate plate, the merging portion has side wall surfaces that linearly connect the supply flow path and the discharge valve, and the discharge valve and the branch valve, respectively.

6. The fluid device according to claim 1,
wherein the flow path includes a first branch flow path and a second branch flow path as the branch flow path,
wherein a first branch valve as the branch valve is provided between the merging portion and the first branch flow path, and
wherein a second branch valve as the branch valve is provided between the merging portion and the second branch flow path.

7. The fluid device according to claim 6,
wherein the first branch valve and the second branch valve are disposed adjacent to each other in a circumferential direction centered on the merging portion, and
wherein when viewed in the thickness direction, the merging portion has a side wall surface that linearly connects together the first branch valve and the second branch valve.

8. The fluid device according to claim 7,
wherein the first branch valve is disposed adjacent to the discharge valve in the circumferential direction centered on the merging portion,
wherein the second branch valve is disposed adjacent to the supply flow path in the circumferential direction centered on the merging portion, and
wherein in the merging portion, a dimension of a region adjacent to the first branch valve in the thickness direction is smaller than a dimension of a region adjacent to the second branch valve in the thickness direction.

9. The fluid device according to claim 8, wherein the merging portion has step portions located between the region adjacent to the first branch valve and the region adjacent to the second branch valve.

10. The fluid device according to claim 1, wherein in the dimension of the merging portion in the thickness direction, the region adjacent to the discharge valve has the smallest dimension.

11. The fluid device according to claim 1, wherein the merging portion has a slanted portion that reduces the dimension in the thickness direction as it goes toward the valve in the region adjacent to at least one valve of the discharge valve and the branch valve.

12. A fluid device comprising:
a substrate which has a pair of substrate plates stacked in a thickness direction thereof,
wherein the substrate is provided with a flow path which is formed by covering a groove portion provided in one substrate plate of the pair of substrate plates with the other substrate plate,
wherein the flow path includes an inflow portion, and an introduction flow path, a supply flow path, and a branch flow path which extend radially from the inflow portion,
wherein the supply flow path and the branch flow path face each other with the inflow portion interposed therebetween,
wherein a branch valve is provided between the inflow portion and the branch flow path,
wherein the inflow portion is filled with a solution by causing the solution to flow from the introduction flow path toward the supply flow path in a state in which the branch valve is closed,
wherein the inflow portion has a facing wall surface that faces the introduction flow path, and
wherein a distance between the introduction flow path and the facing wall surface is larger than a distance between the introduction flow path and the branch valve.

13. The fluid device according to claim 12,
wherein the flow path includes two introduction flow paths,
wherein the two introduction flow paths are disposed symmetrically to each other with respect to a virtual line that connects together the branch flow path and the supply flow path, and
wherein one introduction flow path of the two introduction flow paths is located in the facing wall surface that faces the other introduction flow path.

14. The fluid device according to claim 12, wherein when viewed in the thickness direction, the inflow portion is formed substantially symmetrically with respect to a virtual line that connects together the supply flow path and the branch flow path.

15. The fluid device according to claim 12, wherein an introduction valve is provided between the inflow portion and the introduction flow path.

16. The fluid device according to claim 15, wherein the inflow portion has a slanted portion that reduces a dimension in the thickness direction as it goes toward the valve in a region adjacent to at least one valve of the introduction valve and the branch valve.
